(19) United States
(12) Patent Application Publication
(10) Pub. No.: US 2008/0105160 A1
(43) Pub. Date: May 8, 2008

(54) Ink, ink cartridge and ink ejecting device

(75) Inventors: Takatsugu Doi, Kanagawa (JP); Yoshiro Yamashita, Kanagawa (JP); Ken Hashimoto, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/980,049

(22) Filed: Oct. 30, 2007

(30) Foreign Application Priority Data
Nov. 2, 2006 (JP) 2006-298720

(51) Int. Cl. C09D 11/00; B41J 2/175; G01D 11/00

(52) U.S. Cl. 106/31.6; 347/100; 347/86

(57) ABSTRACT

According to the invention, there is provided an ink comprising a pigment, in which a group having a functional group is chemically bonded to the surface of the pigment, water, and a water-soluble organic solvent, wherein the amount of solid components having a molecular weight of 500 or more in the supernatant when the ink is subjected to centrifugation at a gravitational acceleration of 2×10⁵ G for 60 minutes being in the range of from approximately 0.1 to approximately 35% by mass with respect to the total amount of solid components in the ink.

### CROSS-REFERENCE TO RELATED APPLICATION

This application is based on and claims priority under 35 USC 119 from Japanese Patent Application No. 2006-298720 filed on Nov. 2, 2006.

### BACKGROUND

1. Technical Field

The present invention relates to ink, an ink cartridge and an ink ejecting device.

2. Related Art

An inkjet recording system in which ink is ejected from an ink ejecting device which comprises a nozzle, a slit or a porous film has been widely used in printers due to its small size and low price. In particular, a piezo inkjet system in which ink is ejected utilizing the mechanism of the deformation of a piezoelectric device, and a thermal inkjet system in which ink is ejected utilizing the mechanism of the boiling phenomenon of the ink caused by thermal energy, are characterized by their excellent resolution and high-speed printing property.

Generally, known inks include an aqueous ink containing water as the principal solvent component, and an oil-based ink containing an organic solvent as the principal solvent component. However, it is known that there are problems such as solidification of a colorant in the ink, which is caused by the water used for the solvent of the aqueous ink vaporizing over time, due to its high vapor pressure.

In particular, in the case of an inkjet ink, since the diameter of nozzles for ejecting ink is small, change in states of the ink tends to greatly affect the ink ejecting property. Therefore, when an inkjet head is allowed to stand in a state that the inkjet head is filled with ink over a long period of time, there may arise problems that the nozzles are clogged due to evaporation of water from the tip end of the nozzles or aggregation of a colorant. As a result, deterioration of image quality may arise such that non-ejection where the ink is not ejected or ejected or failure of ink ejection direction where the direction of ink ejection deviates. In this case, when a solid pigment is used as a colorant, the above problems become further remarkable, and further improvements on the nozzle clogging are required.

### SUMMARY

According to an aspect of the invention, there is provided an ink comprising a pigment, in which a group having a functional group is chemically bonded to the surface of the pigment, water, and a water-soluble organic solvent, wherein the amount of solid components having a molecular weight of 500 or more in the supernatant when the ink is subjected to centrifugation at a gravitational acceleration of 2×10⁵ G for 60 minutes being in the range of from approximately 0.1 to approximately 35% by mass with respect to the total amount of solid components in the ink.

### BRIEF DESCRIPTION OF THE DRAWINGS

Exemplary embodiments of the invention will be described in detail based on the following figures, wherein:

FIG. 1 is a perspective view showing an external structure of an exemplary preferable embodiment of a recording apparatus of the invention;

FIG. 2 is a perspective view showing a basic structure of an internal structure of the recording apparatus of FIG. 1;

FIG. 3 is a perspective view showing an external structure of another exemplary preferable embodiment of the recording apparatus of the invention; and

FIG. 4 is a perspective view showing a basic structure of an internal structure of the recording apparatus of FIG. 3.

### DETAILED DESCRIPTION

Hereinafter, the invention will be described in detail.

<Ink>

A first ink (hereinafter may be referred to as “a first aspect of the invention”) is an ink comprising a pigment, in which a functional group is chemically bonded to the surface of the pigment, and water, and an organic solvent, wherein the amount of solid components having a molecular weight of 500 or more in the supernatant when the ink is subjected to centrifugation at a gravitational acceleration of 2×10⁵ G for 60 minutes being in the range of from 0.1 to 35% by mass or approximately 0.1 to approximately 35% by mass with respect to the total solid amount in the ink.

A second ink of the invention (hereinafter may be referred to as “a second aspect of the invention”) is an ink in which the solid content is in the range of from 0.05 to 5% by mass or approximately 0.05 to approximately 5% by mass with respect to the total amount of the ink.

The first aspect of the invention and the second aspect of the invention are the same except that the materials on which the solid content is based are different from each other, and therefore, hereinafter, the common items between the first and second aspects will be described additionally as “the present invention”.

Aqueous ink is allowed stand as such, solvent is evaporated and solid components in the ink are aggregated and solidified. For example, when ink is used for an inkjet recording apparatus, the solidified components are adhered to the tip end of an ejecting nozzle or in the vicinity of a nozzle ejecting port. Accordingly, when the ink is subsequently ejected, failure of ejection direction of the ink ejection may arise, if re-dispersibility of the components in the ink is poor.

On the other hands, pigment having a good stability and coloring property as a colorant, in which a group having a functional group is chemically bonded to the surface of the pigment (hereinafter referred to as “grafted pigment”), has a superior dispersibility and dispersion stability in an aqueous solvent, and therefore, a polymer or the like is not required to be used as a dispersant, and the grafted pigment can be easily dispersed in an aqueous solvent singly. However, as a result of the study by the inventors of the invention, it has been found that when the ink prepared by a grafted pigment alone is solidified, the solidified components cannot easily be re-dispersed in ink due to a large cohesive force among pigment particles.

As a result of further study in this regard, it has been found that even if the grafted pigment is used as a colorant, solidified components can easily be re-dispersed in the ink, if a certain amount of free components (components that are not chemically bonded to pigment) is present in the ink, and the re-dispersibility can be compatible with a good dispersiblity in the ink.

In the invention, “re-dispersed” means that when solidified components are brought into contact with the ink after solidification, the solidified components can be re-dispersed to such an extent that problems do not arise in various usages of ink if the re-dispersed pigment is mixed with the ink. In this case, more specifically, the solidified components brought into contact with the ink are dispersed in the ink, and it is preferable that the ratio of the volume average particle diameter A of the original pigment in the ink to the volume average particle diameter B of the re-dispersed pigment in the ink (B/A) is in the range of from 1 to 5. The determining method thereof will be described later in detail.

The free component in the ink can be determined by the amount of solid components in the supernatant after the ink is subjected to centrifugation. In the invention, it is necessary that the amount of solid components having a molecular weight of 500 or more in the supernatant when the ink is subjected to centrifugation at a gravitational acceleration of 2×10⁵ G for 60 minutes being in the range of from 0.05 to 5% by mass or approximately 0.05 to approximately 5% by mass with respect to the total amount of the ink. Here, “solid components having a molecular weight of 500 or more” do not mean that there is an effective range for the re-dispersiblity by defining the molecular weight of a specific value or higher, but merely means that low molecular weight components, which are not attributable to the dispersibility of the pigment or aggregation when solidification, are not included. However, it is practically impossible that a very high molecular weight component is present in a supernatant, and the upper limit of the molecular weight is about 75,000.

In the case that the amount of the solid component is less than approximately 0.05% by mass, it is difficult to prevent the grafted pigment when solidification from aggregation, the solidified component is not easily re-dispersed. When the solid component exceeds approximately 5% by mass, the free component influences the dispersibility of pigment to cause aggregation of the pigment in the ink.

In the first aspect of the invention, the amount of the solid content is preferably in the range of from 1 to 25% by mass or approximately 1 to approximately 25% by mass, more preferably, in the range of from 1.5 to 15% by mass or approximately 1.5 to approximately 15% by mass. In the second aspect of the invention, the amount of the solid content is preferably in the range of from 0.1 to 4% by mass or approximately 0.1 to approximately 4% by mass, more preferably, in the range of from 0.25 to 3% by mass or approximately 0.25 to approximately 3% by mass.

(Amount of Solid Component)

Hereinafter, the method of determining the amount of solid components P in the invention will be described.

The solid component of the invention can be obtained by distilling away solvent from the supernatant when the ink is subjected to centrifugation at a gravitational acceleration of 2×10⁵ G for 60 minutes. Although the method of centrifugation is not particularly limited as long as the acceleration of gravity is applied, the following method can be used.

First, 8 ml of ink to be measured is placed in a centrifuge tube, and centrifuged at a gravitational acceleration of 2×10⁵ G for 60 minutes. When OPTIMA XL-90 (manufactured by Beckmann Corp.) is used, for example, as a centrifugal machine for centrifugation, the number of revolutions is set at 60,000 rpm. Subsequently, the supernatant is removed from the centrifuge tube, the solvent component such as water is completely evaporated (until the amount of residual water becomes 1,000 ppm or less, hereinafter likewise), and the mass of residue is measured to obtain an amount of solid components P′ in the supernatant.

As described in the above, the amount of the solid components P is based on the components having a molecular weight of 500 or higher. Accordingly, when the components thus obtained contain components having molecular weight of less than 500 (for example, metal salts, dye and the like), it is necessary that this amount is subtracted from the amount of the solid component P′ (in the case that the above components are not contained, P′ as such is the amount of components P of the invention). The amount of components of molecular weight of less than 500 in the amount of the solid components P′ can be estimated by analyzing the solid components by means of a gel permeation chromatography (GPC). The amount of the solid components P of the invention is the mass obtained by subtracting the estimated amount of the low molecular components from the amount of solid components P′.

The ratio of the amount of the solid components in the first aspect of the invention is obtained as a ratio (P/R×100) of the amount of the solid components P to the total amount of solid components in the ink to be measured. The total amount of solid components of the ink is the mass obtained by completely evaporating the solvent from an amount of the ink equivalent to the amount of the ink placed in the centrifuge tube.

The ratio of the amount of the solid components in the second aspect of the invention is obtained as a ratio (P/Q×100) of the amount of the solid components P to the total mass Q of the ink to be measured. The total mass Q of the ink is the mass of the ink placed in the centrifuge tube.

Next, an exemplary embodiment regarding an ink composition and the like will be described in detail.

### (Pigment in Which a Group having a Functional Group is Chemically Bonded to the Surface of the Pigment)

The pigments, in which a group having a functional group is chemically bonded to the surface of the pigment, in the invention (i.e., grafted pigment) include a pigment, in which a group having a functional group is chemically bonded to the surface of the pigment, and a pigment, in which a group having a functional group is chemically bonded to the surface of the pigment via an organic group.

Further, the “chemically bonded” means that the group having a functional group is chemically bonded by a covalent bond, an ionic bond, a coordinate bond and the like. In the invention, as to whether the functional group is chemically bonded to the surface of the pigment is specifically judged by the following methods.

First, a pigment is prepared as a sample for preparing an ink. In the case that pigment in the ink that has been prepared previously is analyzed, 8 ml of ink to be measured is placed in a centrifuge tube, and centrifuged at a gravitational acceleration of 2×10⁵ G for 60 minutes. When OPTIMA XL-90 (manufactured by Beckmann Corp.) is used, for example, as a centrifugal machine for centrifugation, the number of revolutions is set at 60,000 rpm. Then the residue (solid content) is dried to be used as a sample. These samples are subjected to the following operation.

An amount S1 of organic components in the pigment is measured by raising the temperature of the pigment to temperatures (approximately 600° C.) at which organic components including functional groups in the pigment decompose by a thermogravimetric analyzer (TGA). The organic components in the pigment mean the groups which are chemically bonded to the surface of the pigment and have functional groups on the surface of the pigment.

By comparing S1 with P. the state where S1>P is established, is regarded as the state of “the chemically bonded”. The ratio of P with respect to S1 (P/S1) according to an aspect of the invention is less than 1, or less than approximately 1. The ratio is preferably 0.05 or more and less than 0.9, or approximately 0.05 or more and less than approximately 0.9, more preferably 0.1 or more and less than 0.7, or approximately 0.1 or more and less than approximately 0.7, and still more preferably 0.3 or more and less than 0.55, or approximately 0.3 or more and less than approximately 0.55.

The functional groups include, for example, at least one anionic group selected from —COOM, —SO₃M, —PO₃HM, —PO₃M₂, —SO₂NH₂ and —SO₂NHCOR. M in the above formulas represents a hydrogen atom, an alkali metal, an ammonium or an organic ammonium. R represents an alkyl group having 1 to 12 carbon atoms, a substituted or unsubstituted phenyl group or a substituted or unsubstituted naphthyl group.

In the case that M is an alkali metal, the metal includes lithium, sodium and potassium. In the case that M is an organic ammonium, the ammonium includes monomethyl to trimethyl ammoniums, monoethyl to triethyl ammoniums, and monomethanol to trimethanol ammoniums. Among these anionic groups, in particular, —COOM and —SO₃M are preferable in view of a large effect of stabilizing a dispersed state of pigments.

Further, the group having a functional group is preferably composed of an organic group and a functional group. Namely, since the group having a functional group assumes such a structure, the functional group is chemically bonded to the surface of the pigment via the organic group.

The organic groups include, for example, a linear or unsubstituted alkylene group having 1 to 12 carbon atoms, a substituted or unsubstituted phenylene group and a substituted or unsubstituted naphthylene group, and further a polymer chain such as styrene-acrylic copolymer (in this case, the polymer terminal end may become a functional group). The substituted groups that may be bonded to the phenylene group or naphthylene group include a linear or branched alkyl groups having 1 to 6 carbon atoms and the like. Among these groups, styrene-acrylic copolymers having a molecular weight of 5,000 to 75,000 or approximately 5,000 to approximately 75,000 are preferable.

Specific examples of the functional groups that is bonded to the surface of the pigment via the functional group include, for example, —COOH, —C₂H₄COOM, —PhSO₃M, —PhCOOM and the like (Ph represents a phenyl group), but the invention is not limited thereto.

Next, the method for producing the grafted pigments is described.

For example, the grafted pigments can be prepared by allowing to react a pigment with a diazonium salt. The pigments are not specifically limited, but either organic pigments or inorganic pigments may be used. As black pigments include carbon black pigments such as furnace black, lamp black, acetylene black and channel black. In addition to black pigments and three primary color pigments of cyan, magenta and yellow pigments, specific color pigments such as red, green, blue, brown, white pigments and the like, and metal glossy pigments such as gold and silver may be used. Further, newly synthesized pigments for the invention may be used.

Examples of a carbon black which is a black pigment used in the present invention include, but not limited to, Raven7000, Raven5750, Raven5250, Raven5000 ULTRAII, Raven3500, Raven2000, Raven1500, Raven1250, Raven1200, Raven1190 ULTRAII, Raven1170, Raven1255, Raven1080 and Raven1060 (all manufactured by Columbian Carbon); Regal1400R, Regal330R, Regal660R, Mogul L, Black Pearls L, Monarch 700, Monarch 800, Monarch 880, Monarch900, Monarch 1000, Monarch 1100, Monarch 1300 and Monarch1400 (all manufactured by Cabot); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black6, Special Black5, Special Black4A and Special Black4 (all manufactured by Degussa); and No.25, No.33, No.40, No.47, No.52, No.900, No.2300, MCF-88, MA600, MA7, MA8, and MA100 (all manufactured by Mitsubishi Chemical Co., Ltd.).

Examples of a cyan pigment include, but not limited to, C.I.Pigment Blue-1, -2, -3, -15, -15:1, -15:2, -15:3, -15:4, -16, -22 and -60.

Examples of a magenta pigment include, but not limited to, C.I.Pigment Red-5, -7, -12, -48, -48:1, -57, -112, -122, -123, -146, -168, -184 and -202 and C.I.Pigment Violet-19.

Examples of a yellow pigment include, but not limited to, C.I.Pigment Yellow-1, -2, -3, -12, -13, -14, -16, -17, -73, -74, -75, -83, -93, -95, -97, -98, -114, -128, -129, -138, -151, -154, -155 and -180.

Further, pigment particles covered with resins or the like may be used. These are called microcapsule pigments, and not only microcapsule pigments commercially available from Dainippon Ink & Chemicals Inc. and Toyo Ink Manufacturing Co., Ltd., but also microcapsule pigments prepared for the present embodiment can be used. Furthermore, a dispersion of a resin colored with dyes or pigments, so-called colored particles can be used.

As described in the above, the grafted pigment is produced, for example, by allowing to react the above pigment with a diazonium salt in a liquid reaction medium, to combine a group having at least one kind of the functional groups with the surface of the pigment particles. Suitable reaction media include water, medium containing water, and medium containing alcohol, and the most preferable medium is water. A method of manufacturing these grafted products in the case that the pigment is carbon black is recited in U.S. patent application Ser. No. 08/356,660, and a method of manufacturing these grafted products in the case that the pigment is not carbon black is disclosed in U.S. patent application Ser. No. 08/356,653.

In order to produce these grafted pigments, it is necessary that the diazonium salts are sufficiently stable to be able to be reacted with the pigments. That is, the reaction of the pigments takes place with some of diazonium salts, and it is considered that the rest thereof is unstable and is decomposed. Some decomposing processes compete with the reaction between the pigment and the diazonium salt, and the competition may result in reduction in the total number of functional groups that combine with the pigment. Further, the reaction may be carried out at high temperatures at which a considerable amount of the diazonium salt is decomposed. Furthermore, such high temperature conditions may lead to an increase in the solubility of the diazonium salt in a reaction medium and improvements on handling between processes, but on the contrary, may result in a partial loss of the diazonium salt due to another decomposing process.

Further, when organic groups are introduced between the functional groups and the surface of the pigment, a method in which, for example, after a low molecular weight group having specific functional groups has been bonded to the surface of the particles of the pigment as described in the above, a compound having desired organic groups is added to the reaction system to react the organic groups with the functional groups, and thereafter, a compound having functional groups may be further optionally added to the system to react with free terminal ends of the organic groups, to introduce functional groups, can be used.

The reaction of the pigment with the diazonium salts can be carried out in an aqueous slurry of pigment or in a dispersion system in which granulated pigment is dispersed. Further, pellets of pigment may be prepared by using conventional granulation techniques. When the grafted pigment is used, for example, for an ink for inkjet recording, the pigment is preferably pulverized in a fine particle size before the pigment is subjected to the reaction, in order to prevent the pigment from sedimentation.

In addition, as the pigment, in which a group having a functional group is bonded to the surface of the pigment, commercially available pigments that are self-dispersible in water may be used. The pigments that are self-dispersible in water have a number of water-soluble groups (functional groups) on the surface of the pigments, and are stably dispersed in water even without the presence of a polymer dispersant. Specifically, the pigments that are self-dispersible in water can be obtained in such a manner that so-called conventional pigments are subjected to a surface-modifying treatment such as an acid/base treatment, treatment with a coupling agent, polymer graft treatment, plasma treatment, oxidation-reduction treatment, and the like.

In addition to the above-mentioned pigments which have been subjected to surface modifying treatment, commercially available self-dispersible pigments, e.g. Cab-o-jet-200, Cab-o-jet-250, Cab-o-jet-260, Cab-o-jet-270, Cab-o-jet-300, IJX-444, and IJX-55 (all manufactured by Cabot), and Microjet Black CW-1, and CW-2 (all manufactured by Orient Chemical Industries, Ltd. ) may also be used as a pigment which is self-dispersible in water.

In the present embodiment, the amount of the solid components in the supernatant can be controlled by the following method (A) or (B):

(A) an ink is prepared using a pigment component formed by controlling, when a pigment is allowed to react with the diazonium salt, the reactivity of the compound having functional groups to be subjected to the reaction with the pigment so as to make the amount of the solid component in the ink in a desired range; or

(B) after the grafted pigment is produced as described in the above, the amount of the solid components in ink is controlled by adding a polymer component or the like, when the ink is prepared.

Here, the method (A) is explained, and the method (B) will be explained later.

In the method (A), the control of the reaction of the compound having functional groups with the pigment can be made by adjusting the particle diameter of the pigment, and the quantity of impurities contained in the pigment.

With respect to the particle diameter of the pigment, a pigment component having a smaller diameter has a larger specific surface area and the ratio of the compound having functional groups to the pigment in the reaction system becomes larger, so that the reaction rate is lowered, and functions as a grafted pigment do not appear, but functions as a collective body of unreacted free components appear. Accordingly, the amount of solid component can be reduced by reducing the ratio (quantity) of the pigment having a smaller diameter. To the contrary, the increase in the ratio of the pigment having a smaller diameter results in an increase in the amount of solid components.

In the present embodiment, the volume average particle diameter of the pigment particles is preferably in the range of from 50 to 200 nm or approximately 50 to approximately 200 nm, and more preferably, in the range of from 75 to 150 nm or approximately 75 to approximately 150 nm. When the volume average particle diameter is less than approximately 50 nm, the amount of solid components in the supernatant may not be in the desired range, and when the volume average particle diameter exceeds approximately 200 nm, re-dispersion of solidified ink may become difficult.

The volume average particle diameter of the pigment particles means the diameter of the pigment particles per se, or the diameter of particles on which an additive adheres in the case that the additive such as a dispersant adheres to the pigment particles. The volume average particle diameter when measured with pigment alone, is equivalent to the particle diameter of the pigment in ink prepared using the pigment.

The measurement of the volume average particle diameter is carried out by the use of a Microtrack UPA Particle Size Analyzer 9340 (manufactured by Leeds & Northrup). The measurement is carried out according to a prescribed measurement method in which 4 ml of ink is placed in a measurement cell. As parameters inputted at the time of measurement, the viscosity of the ink is used for the viscosity, and the density of the colorant is used for the density of the dispersion particles.

With regard to impurities in the pigment, the chemical bond between the surface of the particles of the pigment and the group having a functional group is inhibited when impurities are present, or a reaction where the group having a functional group is introduced to the impurities takes place, resulting in an increase in the amount of solid component. Accordingly, the pigment is washed before the group having a functional group is introduced to reduce the amount of the impurities, so that the reaction rate of the pigment with the group having a functional group becomes higher and the amount of solid component can be reduced.

As the method of washing the pigment, it is preferable that the pigment is added into water and dispersed by an ultrasonic disperser, and thereafter, only solid components are fractionated by the use of a centrifugal machine. In this method, by adjusting the number of washing times, and time for the ultrasonic dispersion, preferable pigment used for the ink of the present embodiment can be obtained.

In the present embodiment, the content of the pigment contained in ink is preferably in the range of from 1 to 25% by mass or approximately 1% by mass to approximately 25% by mass relative to the total amount of the ink, more preferably in the range of from 4 to 22.5% by mass or approximately 4% by mass to approximately 22.5% by mass, and further more preferably in the range of from 7.5 to 20% by mass or approximately 7.5% by mass to approximately 20% by mass. In the case that the content of the pigment in the ink is less than approximately 1% by mass, sufficient optical density may not be obtained, and in the case that the content of the pigment in the ink is higher than approximately 25% by mass, the dispersion of the pigment becomes unstable so that aggregation of the pigment component may take place after the storage thereof for a long period of time.

(Water)

Water used for an ink of the present embodiment may be any of tap water, distilled water, ion-exchange water, pure water or ultra-pure water, preferably distilled water, ion-exchange water, pure water and ultra-pure water, and more preferably an ion-exchange water, a pure water and an ultra pure water are used, from the viewpoint of the storage stability of the ink and the prevention of clogging,

In the present embodiment, the content of water in ink is preferably in the range of from 30 to 80% by mass or approximately 30 to approximately 80% by mass, and more preferably in the range of from 35 to 70% by mass or approximately 35 to approximately 70% by mass. When the content of water is less than approximately 30% by mass, the fluidity characteristics may become unstable, resulting in inconvenience of handling. On the other hand, when the content of water exceeds approximately 80% by mass, and the dispersibility of the ink is deteriorated after the storage thereof for a long period of time.

(Water-Soluble Organic Solvent)

Water-soluble organic solvent may be contained in the ink of the present embodiment.

Specific examples of the water-soluble organic solvent include a derivative of polyhydric alcohol, an alkyl ether thereof or the like; e.g. glycerin, polyethylene glycol, polypropylene glycol, diethylene glycol, diethylene glycol monobutyl ether, diethylene glycol phenyl ether, propylene glycol, propylene glycol monomethyl ether, butylene glycol, triethylene glycol, thiodiethanol, hexylene glycol, ethylene glycol, ethylene glycol methyl ether, diethylene glycol methyl ether, pentane diol, hexane diol (e.g. 1,2-hexane diol), hexane triol, trimethylol propane and diglycerine ethylene oxide adduct. These examples can be used either alone or in a combination of two or more thereof.

Furthermore, alcohols such as methyl alcohol, ethyl alcohol, n-propyl alcohol, isopropyl alcohol, n-butyl alcohol, hexyl alcohol and benzyl alcohol; amides such as dimethyl formamide and dimethyl acetamide; ketones and ketoalcohols such as acetone and diacetone alcohol; nitrogen containing solvents having a high boiling point such as triethanol amine, diethanol amine, pyrrolidone, N-methyl-2-pyrrolidone, and 1,3-dimethyl-2-imidazolydinone; sulfur containing solvents such as dimethyl sulfoxide, diethyl sulfoxide, sulforan, and thiodiethanol; saccharides and derivatives thereof such as glucose, maltose, amirose (dextrin), cellulose and sodium alginate; gum Arabic or the like can also be used although the present invention is not limited thereto. These water-soluble organic solvents may be used alone or in combination of two or more.

The content of the water-soluble organic solvent contained in the ink is preferably in the range of from 1 to 50% by mass or approximately 1 to approximately 50% by mass with respect to the total amount of the ink, and more preferably in the range of from 3 to 30% by mass or approximately 3 to approximately 30% by mass. When the content thereof is less than approximately 1% by mass, re-dispersibility of the ink is deteriorated after the storage thereof for a long period of time. When the content thereof exceeds approximately 50% by mass, the viscosity of the ink increases, resulting in difficulty of handling of the ink

(Other Additives)

Various kinds of additives for improving dispersibility of pigment and liquid property may be added to the ink of the invention, in addition to the specific pigments, water and water-soluble solvents.

Since the solid components, enumerated below, having a molecular weight of 500 or more soluble in the above solvents, become the solid components in the supernatant after centrifugation as described above, the addition of these components into the ink corresponds to the method (B) where the solid components in the supernatant are controlled.

For the purpose of dispersing the colorant, a dispersant such as a nonionic compound, an anionic compound, a cationic compound, an ampholytic compound and the like, which is preferably a polymer dispersant, may be used for the present embodiment.

For example, copolymers of monomers having an α,β-ethylene unsaturated group can be used as the above-mentioned dispersant. Examples of the monomer having an α,γ-ethylene unsaturated group include ethylene, propylene, butene, pentene, hexene, vinyl acetate, allyl acetate, acrylic acid, methacrylic acid, crotonic acid, crotonic ester, itaconic acid, itaconic acid monoester, maleic acid, maleic acid monoester, maleic acid diester, fumaric acid, fumaric acid monoester, vinyl sulfonic acid, styrene sulfonic acid, vinyl naphthalene sulfonate, vinyl alcohol, acrylamide, methacryloxyethyl phosphate, bismethacryloxyethyl phosphate, methacryloxyethyl phenyl acid phosphate, ethylene glycol dimethacrylate, diethylene glycol dimethacrylate, styrene, α-methylstyrene, styrene derivative e.g. vinyl toluene, vinyl cyclohexane, vinyl naphthalene, vinyl naphthalene derivative, acrylic acid alkylester, phenyl acrylate, alkyl methacrylate, phenyl methacrylate, cycloalkyl methacrylate, alkyl crotonate, dialkyl itaconate, dialkyl maleinate, vinyl alcohol, and derivatives thereof.

The copolymer obtained by copolymerizing one or more kinds of monomer having an α,β-ethylene unsaturated group may be used as a polymer dispersant. Specific examples of the copolymer include styrene-styrene sulfonate copolymer, styrene-maleic acid copolymer, styrene-methacrylic acid copolymer, styrene-acrylic acid copolymer, vinylnaphthalene-maleic acid copolymer, vinylnaphthalene-methacrylic acid copolymer, vinylnaphthalene-acrylic acid copolymer, alkyl acrylate-acrylic acid copolymer, alkyl methacrylate-methacrylic acid copolymer, styrene-alkyl acrylate-acrylic acid copolymer, styrene-alkyl methacrylate-methacrylic acid copolymer, styrene-phenyl methacrylate-methacrylic acid copolymer and styrene-cyclohexyl methacrylate-methacrylic acid copolymer, polystyrene, polyester and polyvinyl alcohol.

Polymer dispersants used in the ink of the present embodiment have preferably a weight average molecular weight of 3,000 to 50,000 or approximately 3,000 to approximately 50,000, more preferably 3,500 to 40,000 or approximately 3,500 to approximately 40,000, still more preferably 4,000 to 30,000 or approximately 4,000 to approximately 30,000. When the molecular weight is less than approximately 3,000, the function as a dispersant may not be obtained, and on the other hand, when the molecular weight exceeds approximately 50,000, difficulties in handling may arise when used as an ink.

The above-mentioned weight-average molecular weight is measured in accordance with gel permeation chromatography (GPC), using HLC-8120GPC, SC-8020 (manufactured by Toso Corp.); two of TSK gel, super HM-H (manufactured by Toso Corp., 6.0 mm ID×15 cm) as the columns; a THF (tetrahydrofuran) as a solvent; at the sample concentration of 0.5%; flow rate of 0.6 ml/min; sample injection amount of 10 μl; measurement temperature of 40° C.; using an IR detecting device.

A calibration line is obtained from 10 samples of “polystyrene standard sample TSK standard” (manufactured by Toso Corp.): “A-500”, “F-1”, “F-10”, “F-80”, “F-380”, “A-2500”, “F-4”, “F-40” and “F-128”, “F-700”.

The acid value of the polymer dispersant used in the ink of the present embodiment is preferably 50 to 400, more preferably 60 to 250, and further preferably 70 to 200.

To measure the acid value of the polymer, a known method e.g. a method based on the JIS K0070 may be used. Specifically, the acid value can be measured by conducting a neutralization titration using a neutralizing agent (KOH) with a resin dissolved in an organic solvent such as a THF or a toluene.

Additionally, the neutralization degree of the polymer dispersant used in an ink of the present embodiment is preferably 20 to 100%, more preferably 30 to 90%, and further preferably 40 to 80%. In a case where the neutralization degree of the dispersant is less than 50%, the pigment at the initial stage after the ink is prepared may not be stably dispersed. On the other hand, in a case where the neutralization degree exceeds 100%, the ejection property of the ink after the long-term storage, as well as the ink at the initial stage after the ink is prepared, may be deteriorated.

The neutralization degree can be calculated in accordance with the following formula wherein the measurement result of the above-mentioned acid value is used;

Neutralization degree=neutralizing agent by weight (g)/resin by weight (g)/neutralizing agent by molecular weight/(acid value/56,100)

The dispersant to be added into the ink is used preferably in the range of from 1 to 100% by mass or approximately 1% to approximately 100% by mass ratio at an addition amount ratio relative to the pigment. When the addition amount ratio exceeds approximately 100%, the dispersibility of the pigment in the ink may be deteriorated due to excessive solid in the supernatant. On the other hand, the addition amount ratio is less than approximately 1%, the sufficient dispersibility of solidified ink may not obtained. The addition amount ratio of the dispersant is preferably 2.5 to 75% or approximately 2.5% or more and approximately 75% or less.

A surfactant may be added in the ink in the embodiment. Specific examples of the surfactants are shown below but are not limited to them. Examples of the surfactant which can be added in ink include a nonionic surfactant, an anionic surfactant, or an amphoteric surfactant. Additionally, an anionic surfactant, cationic surfactant, an amphoteric surfactant, and a nonionic surfactant, and further the above-mentioned dispersants may also be used.

Examples of the nonionic surfactants include polyethylene glycol-based surfactants, e.g. higher alcohol alkylene oxide adduct, alkylphenol alkylene oxide adduct, fatty acid alkylene oxide adduct, polyvalent alcohol fatty acid ester alkylene oxide adduct, fatty acid amide alkylene oxide adduct and polyalkylene glycol alkylene oxide adduct; and polyvalent alcohol-based surfactants, e.g. glycerol fatty acid ester, polyvalent alcohol alkylether and alkanolamine fatty acid amides.

Specific examples of the nonionic surfactant include polypropyleneglycol-ethylene oxide adduct, polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylene sorbitan fatty acid ester, fatty acid alkylolamide, acetyleneglycol, acetyleneglycol-oxyethylene adduct, aliphatic alkanolamide, glycerin ester and sorbitan ester.

Examples of the anionic surfactant include carboxylate salt, sulfate ester salt, sulfonic acid salt, phoshate salt; e.g. alkylbenzene sulfonate, alkylphenyl sulfonate, alkylnaphthalene sulfonate, higher fatty acid salts, sulfate ester salt of higher fatty acid esters, sulfonate of higher fatty acid esters, sulfate ester salt or sulfonate of higher alcohol ethers, higher alkyl sulfosuccinate, higher alkyl phosphate ester salt and phosphate ester salts of higher alcohol-ethylene oxide adducts.

Additional effective examples include dialkylsulfo succinate, alkylsulfonate, dodecylbenzene sulfonate, kellyl benzene sulfonate, isopropylnaphthalene sulfonate, monobutylphenylphenol monosulfonate, monobutylbiphenyl sulfonate, monobutylbiphenyl sulfonate and dibutylphenylphenol disulfonate.

Examples of the amphoteric surfactant include carboxylate salt-based surfactant such as amino acid-based surfactant and betaine-based surfactant; sulfate ester-based surfactant, sulfonic acid-based surfactant, phosphoric ester-based surfactant. Other examples thereof such as alanine-based surfactant, amidopropylbetaine-based surfactant, sulfobetaine-based surfactant, amidoamine oxide-based surfactant and imidazoline-based surfactant; e.g. alkylbetaine, sulfobetaine, sulfate betaine, imidazolidone betaine, amidopropylbetaine and aminodipropionate salt may also be used.

Examples of the cationic surfactant include tetraammonium alkyl salt, alkylamine salt, benzalkonium salt, alkyl pyridium salt and imidazolium salt; e.g. dihydroxyethyl stearylamine, 2-heptadecenyl-hydroxyethyl imidazoline, lauryldimethylbenzyl ammonium chloride, cetylpyridium chloride and stearamide methylpyridium chloride.

A bio-surfactant such as spicrispolic acid, rhamnolipid and lysolecithin may also be used.

In the present embodiment, the surfactant may be used alone or in combination of two or more. The content of the surfactant added in ink relative to the total amount of the ink is preferably approximately 10% or less by mass and more preferably 0.01 to 5% by mass or approximately 0.01 to approximately 5% by mass.

In the present embodiment, when ink is used for an ejecting device of an inkjet system, the ink further contains preferably a polymer component for the purpose of improving an ink ejection property or the like. The polymer components include polyethylene imine, polyamines, polyvinyl pyrrolidone, polyethylene glycol; cellulose derivatives such as ethylcellulose and carboxymethyl cellulose; polysaccharides and the derivatives thereof; other water-soluble polymers; polymer emulsions such as acrylic polymer emulsion, polyurethane emulsion and hydrophilic latex; and hydrophilic polymer gel.

In order to control the electroconductivity and the pH value, compounds of alkali metals such as potassium hydroxide, sodium hydroxide, lithium hydroxide; nitrogen-containing compounds such as ammonium hydroxide, triethanol amine, diethanol amine, ethanol amine, 2-amono-2-methyl-1-propanol; alkali earth metal compounds such as calcium hydroxide; acids such as sulfuric acid, hydrochloric acid, nitric acid; and salts of a strong acid and a weak alkali such as ammonium sulfate, can be used.

An additive such as an antioxidant, an antifungal agent, a conductive agent, an ultraviolet ray absorbing agent, a chelating agent and the like, may optionally be used in the present embodiment. Any known additives may be used in the present embodiment, e.g. as the chelating agent, ethylene diamine tetraacetate (EDTA), imino diacetate (IDA), ethylene diamine-di(o-hydroxy phenyl acetate) (EDDHA), nitrilotriacetate (NTA), dihydroxy ethyl glycine (DHEG), trans-1,2-cyclohexane diamine tetraacetate (CyDTA), diethylene triamine-N,N,N′,N″,N″-pentaacetate (DTPA), glycol ether diamine-N,N,N′,N′-tetraacetate (GEDTA).

(Ink Properties)

When the ink of the embodiment is used as an ink for inkjet for a mechanism for applying an ink by means of an inkjet system, the ink may not normally ejected if the viscosity of the ink is high. Suitable viscosity for the inkjet ink is preferably 1 to 50 mPa·s, more preferably 1.2 to 50 mPa·s, and further more preferably 1.5 to 30 mPa·s. The viscosity (including the viscosity described hereinafter) is measured by the use of a rotary viscometer (RHEOMAT 115 manufactured by Contraves) at a shear rate of 1,400s⁻¹ at 23° C.

Further, the surface tension of the ink of the embodiment is preferably adjusted by containing the surfactants, polyalcohols, monoalcohols and the like. The surface tension of the ink adjusted by the above method is preferably in the range of from 20 to 40 mN/m, more preferably in the range of from 20 to 35 mN/m, and still more preferably in the range of from 25 to 35 mN/m. The surface tension is measured by the use of a Wilhelmy type surface tension balance under the conditions of 23° C.and 55% RH.

(Ink Preparation Method)

Next, an exemplary method for preparing ink is described.

In the present embodiment, the ink can be obtained in such a manner that for example, when the amount of the solid component is controlled by the method (A) as described in the above, a predetermined amount of pigment in which an amount of free component is adjusted is added to water, or for example, when the amount of solid component is controlled according to the method (B) as describe in the above, a predetermined amount of pigment is added to an aqueous solution containing a predetermined amount of the dispersant and the like, and after the mixture is stirred, the pigment is dispersed by the use of a dispersing machine, and coarse particles are removed from the dispersion by the use of a centrifugal machine, and thereafter, predetermined amounts of the water-soluble organic solvent and the additives and the like are added, stirred and mixed, followed by filtration. In this case, a thick dispersion of pigment is prepared previously, the dispersion can be diluted at the time when the ink is prepared. Further, a process of pulverizing of the pigment may be provided prior to the dispersing process. Alternatively, after a predetermined amount of the water-soluble organic solvent, water and a dispersant are mixed, the pigment is added thereto, and the mixture may be dispersed by the use of a dispersing machine.

As the above-mentioned dispersing machine, commercially available ones can be used; e.g. a colloid mill, a flow-jet mill, a slasher mill, a high-speed disperser, a ball mill, an attritor, a sand mill, a sand grinder, a ultra-fine mill, an Aigar motor mill, a Dyno mill, a pearl mill, an agitator mill, a cobol mill, a three-bar roll, a two-bar roll, an extruder, a kneader, a micro fluidizer, a laboratory homogenizer, an ultrasonic homogenizer. These machines can be used alone or in combination of two or more. To prevent the inorganic impurity being mixed in, it is preferable to use a dispersing method without using a dispersion medium. In this case, it is preferable to use a micro fluidizer, an ultrasonic homogenizer or the like.

The ink of the invention can be used as an ink set composed of a plurality of inks, and further, as an ink set composed of the ink and a processing solution containing at least an aggregation agent.

By the use of the ink set composed of the ink of the invention and the processing solution containing at least an aggregation agent, the image quality such as an optical density and an ink bleed can be improved. This is considered that the colorant in the ink is aggregated by mixing the ink and the processing solution on a recording medium. Namely, it is presumed that by increasing the concentration of the colorant on the recording medium, the optical density can be increased, and since the colorant does not diff-use together with the ink, the ink bleed can be improved.

Details of a processing solution used as an ink set are herein described.

The processing solution used in the present embodiment contains at least an aggregating agent.

The aggregating agent is a substance which has an effect to react or interact with a component in the ink to increase the viscosity or cause the aggregation. Examples of such substance include a polyvalent metal ion and a cationic substance; specifically, substance such as an inorganic electrolyte, an organic amine compound and an organic acid, as described below, are effectively used.

Examples of an inorganic electrolyte include salts of an alkali metal ion such as lithium ion, sodium ion, potassium ion; polyvalent metal ions such as aluminum ion, barium ion, calcium ion, copper ion, iron ion, magnesium ion, manganese ion, nickel ion, tin ion, titanium ion and zinc ion and hydrochloric acid, hydrobromic acid, hydriodic acid, sulfuric acid, nitric acid, phosphoric acid, thiocyanic acid; organic carboxilic acid such as acetic acid, oxalic acid, lactic acid, fumaric acid, citric acid, salicylic acid and benzoic acid; and organic sulfonic acid.

Specific examples of these include alkali metal salts such as lithium chloride, sodium chloride, potassium chloride, sodium bromide, potassium bromide, sodium iodide, potassium iodide, sodium sulfate, potassium nitrate, sodium acetate, potassium oxalate, sodium citrate and potassium benzoate; salts of polyvalent metal such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate and zinc acetate.

Examples of organic amine compound include primary, secondary, tertiary and quaternary amines and salts thereof.

Examples include tetraalkylammonium salt, alkylamine salt, benzalkonium salt, alkylpyridium salt, imidazolium salt, and polyamine; e.g. isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethylenediamine, diethylenetriamine, tetraethylenepentamine, diethanolamine, diethylethanolamine, triethanolamine, tetramethylammonium chloride, tetraethylammonium bromide, dihydroxyethylstearylamine, 2-heptadecenyl-hydroxyethylimidazoline, lauryldimethylbenzylammonium chloride, cetylpyridinium chloride, stearamidomethylpyridinium chloride, diallyldimethylammonium chloride polymer, diallylamine polymer and monoallylamine polymer; onium salts thereof such as sulfonium salt and phosphonium salt; and phosphoric acid esters thereof.

The organic acid is preferably a compound represented by the following formula (1).

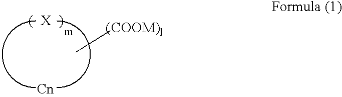

In the formula (1), X represents O, CO, NH, NR, S or SO₂, preferably CO, NH, NR or O, more preferably CO, NH or O;

R represents an alkyl group, preferably CH₃, C₂H₅ or C₂H₄OH; M represents a hydrogen atom, an alkali metal or an amine, preferably H, Li, Na, K, a monoethanolamine, a diethanolamine or a triethanolamine, more preferably H, Na or K, and further preferably a hydrogen atom;

n is an integer of 3 to 7, preferably the case where a heterocyclic ring is six- or five-membered, more preferably five-membered; m is 1 or 2.

The compound represented by the formula (1) may be either a saturated ring or an unsaturated ring as long as the compound is a heterocyclic ring; 1 is an integer of 1 to 5.

The compound represented by the formula (1) specifically indicates a compound having a furan, pyrrole, pyrroline, pyrrolidone, pyrrone, pyrrole, thiphene, indole, pyridine or quinoline structure, and further having a carboxyl group as a functional group. Specific examples thereof include 2-pyrrolidone-5-carboxylic acid, 4-methyl-4-pentanolide-3-carboxylic acid, furancarboxylic acid, 2-benzofurancarboxylic acid, 5-methyl-2-furancarboxylic acid, 2,5-dimethyl-3-furancarboxylic acid, 2,5-furandicarboxylic acid, 4-butanolide-3-carboxylic acid, 3-hydroxy-4-pyrrone-2,6-dicarboxylic acid, 2-pyrrone-6-carboxylic acid, 4-pyrrone-2-carboxylic acid, 5-hydroxy-4-pyrrone-5-carboxylic acid, 4-pyrrone-2,6-dicarboxylic acid, 3-hydroxy-4-pyrrone-2,6-dicarboxylic acid, thiophenecarboxylic acid, 2-pyrrolecarboxylic acid, a 2,3-dimethylpyrrole-4-carboxylic acid, 2,4,5-trimethylpyrrole-3-propionic acid, 3-hydroxy-2-indolecarboxylic acid, 2,5-dioxo-4-methyl-3-pyrroline-3-propionic acid, 2-pyrrolidinecarboxylic acid, 4-hydroxyproline, 1-methylpyrolidine-2-carboxylic acid, 5-carboxy-1-methylpyrolidine-2-acetic acid, 2-pyridinecarboxylic acid, 3-pyridinecarboxylic acid, 4-pyridinecarboxylic acid, pyridinedicarboxylic acid, pyridinetricarboxylic acid, pyridinepentacarboxylic acid, 1,2,5,6-tetrahydro-1-methylnicotinic acid, 2-quinolinecarboxylic acid, 4-quinolinecarboxylic acid, 2-phenyl-4-quinolinecarboxylic acid, 4-hydroxy-2-quinolinecarboxylic acid, 6-methoxy-4-quinolinecarboxylic acid, and derivative or salt thereof.

The compound represented by the formula (1) is preferably pyrrolidonecarboxylic acid, pyrronecarboxylic acid, pyrrolecarboxylic acid, furancarboxylic acid, pyridinecarboxylic acid, coumalic acid, thiophencarboxylic acid, nicotinic acid, or derivative or salt thereof; and more preferably pyrrolidonecarboxylic acid, pyrronecarboxylic acid, furancarboxylic acid, coumalic acid, and derivative or a salt thereof.

Examples of the above-mentioned compounds are preferably magnesium chloride, magnesium bromide, magnesium iodide, magnesium sulfate, magnesium nitrate, magnesium acetate, calcium chloride, calcium bromide, calcium nitrate, calcium dihydrogen phosphate, calcium benzoate, calcium acetate, calcium tartarate, calcium lactate, calcium fumarate, calcium citrate, diallyldimethylammonium chloride polymer, diallylamine polymer, monoallylamine polymer, pyrrolidonecarboxylic acid, pyrronecarboxylic acid, pyrrolecarboxylic acid, furancarboxylic acid, pyridinecarboxylic acid, coumalic acid, thiophenecarboxylic acid, nicotinic acid, potassium dihydrogen citrate, succinic acid, tartaric acid, lactic acid, potassium hydrogen phthalate, and derivative or salt thereof; more preferably magnesium chloride, magnesium nitrate, calcium nitrate, diallylamine polymer, pyrrolidonecarboxylic acid, pyrronecarboxylic acid, furancarboxylic acid, coumalic acid, and derivative or salt thereof.

In the present invention, aggregating agents may be used alone or in combination of two or more.

The amount of the aggregating agent to be added in a processing solution is preferably 0.01 to 30% by mass or approximately 0.01 to approximately 30% by mass, more preferably 0.1 to 15% by mass or approximately 0.1 to approximately 15% by mass, further preferably 0.25 to 10% by mass or approximately 0.25 to approximately 10% by mass, relative to the total mass of a processing solution.

The same kind of water-soluble organic solvent as the one used in the ink may be used for the processing solution.

The content of the water-soluble organic solvent is used within the range of 1 to 60% by mass or approximately 1 to approximately 60% by mass, preferably 5 to 40% by mass or approximately 5 to approximately 40% by mass, relative to the total mass of a processing solvent.

Water may be added to a processing solution within the range that the above-mentioned surface tension and viscosity of the solution is obtained. The amount of water to be added is not particularly limited, but preferably 10 to 99% by mass or approximately 10 to approximately 99% by mass, more preferably 30 to 80% by mass or approximately 30 to approximately 80% by mass, relative to the total mass of a processing solution.

A colorant may also be included in the processing solution, if desired. The same kind of colorant as the one used in the ink may be used for the processing solution. Preferable examples of the colorant include a dye, a pigment having a sulfonic acid or a sulfonate salt on its surface, an anionic self-dispersible pigment or a cationic self-dispersible pigment. Such a colorant, being hard to aggregate in an acidic region, is considered to be effective to improve the storage stability of the processing solution.

The same kind of surfactant as the one used in the ink may be used for the processing solution. The amount of the surfactant to be added is preferably less than approximately 10% by mass, more preferably 0.01 to 5% by mass or approximately 0.01 to approximately 5% by mass, and further preferably 0.01 to 3% by mass or approximately 0.01 to approximately 3% by mass, relative to the total mass of a processing solution.

Other additives, e.g. polyethyleneimine, polyamine, polyvinylpyrrolidone, polyethylene glycol, cellulose derivative such as ethylcellulose and carboxymethylcellulose, polysaccharide and derivative thereof; emulsion of a polymer such as water-soluble polymer, acryl-based polymer, polyurethane-based polymer and hydrophilic latex; hydrophilic polymer gel, cyclodextrin, macrocyclic amine, dendrimer, crown ethers, urea and derivative thereof, acetamide, silicone-based surfactant, fluorine-based surfactant, water, compound of an alkali metal such as potassium hydroxide, sodium hydroxide and lithium hydroxide; nitrogen-containing compound such as ammonium hydroxide, triethanolamine, diethanolamine, ethanolamine and 2-amino-2-methyl-1-propanol; compounds of alkaline earth metals such as calcium hydroxide; acid such as sulfuric acid, hydrochloric acid and nitric acid; salt of strong acid and weak alkali such as ammonium sulfate, pH buffer agent, antioxidant, antifungal agent, viscosity modifier, conductive agent, and ultraviolet ray absorbing agent may also be used.

The surface tension of a processing solution is preferably 10 to 45 mN/m, more preferably 15 to 40 mN/m, and further preferably 20 to 35 mN/m. The surface tension of the processing solvent is preferably smaller than the surface tension of ink.

Further, the viscosity of the processing solution is preferably 1.2 to 15 mPa·s, more preferably 1.5 to 10 mPa·s, and further more preferably 1.8 to 8 mPa·s. The pH value of the processing solution containing the compound represented by the formula (1) is preferably 1.5 to 12.0, more preferably 2.0 to 7.5, and still further preferably 2.5 to 6.0.

The number of a coarse particle having a size of approximately 5 μm or larger in a mixture of the ink and the processing solution is preferably more than approximately 500/μL, more preferably 500 to 10,000/μL and further preferably 500 to 3,000/μL. In a case where the number of a coarse particle having a size of approximately 5 μm or larger contained in a mixture of ink and processing solution is less than approximately 500/μL, the optical density may be reduced.

In the present invention, the number of the coarse particle having a size of 5 μm or larger in a mixture of the ink and the processing solvent was measured in accordance with the following process: mixing the two liquids at a ratio of 1:1 by mass; sampling a 2 μL of the mixture while stirring; and measuring the number of particle by Accusizer TM770 Optical Particle Sizer (manufactured by Particle Sizing Systems Inc.). As a parameter to be input, density of a colorant is used for the density of a dispersed particle. The density of a colorant can be calculated by measuring the colorant powder by a gravimeter or a pycnometer, the powder being obtained by heating and drying a solution in which the colorant is dispersed.

<Ink Cartridge>

The ink cartridge of the invention is constituted such that at least the ink of the invention is accommodated in a container, and further includes other members and the like selected as occasion demands. In other words, the ink cartridge of the invention includes not only a container accommodating the ink therein, but also parts equipped with a recording head and the like, and may be a cartridge as a replaceable part that can be detachably mounted to an ink ejecting device.

The container is not specifically limited, but the shape, configuration, material or the like of the container can be selected according to purposes, and, for example, a container having at least a bag formed of a laminated aluminum film, resin film and the like is preferably exemplified. Further, as the container, for example, the containers described in JP-A No. 2001-138541 and the like can be used.

In this case, since the ink cartridge is filled with the ink and the processing solution of the invention, the change in ink characteristics during storage of the ink cartridge over a long period of time can be prevented, and at the time when the ink is ejected from the ink head, in particular, from the ink head that has been stored over a long period of time, the ink ejection characteristics from the ink head can be fully satisfactory.

<Ink Ejecting Device>

The ink ejecting device of the invention comprises an ink cartridge in which an ink and an ink set are accommodated, and an ejecting unit for ejecting each of the liquids as describe in the above onto a recording medium. These are applicable to not only a regular inkjet recording apparatus, but also a recording apparatus equipped with a heater or the like for controlling ink drying, or a recording apparatus equipped with an intermediate transfer mechanism in which after printing on an intermediate member, the print on the intermediate member is transferred onto a recording medium such as paper or the like. In particular, an inkjet recording apparatus having an inkjet system is preferable in view of effectively exploiting the action of the ink of the invention.

A thermal inkjet recording system and a piezo inkjet recording system are preferably applied to the inkjet ejecting device of the present invention, from the viewpoint of improving feathering and intercolor bleeding.

In the thermal inkjet recording system, although the reason is not exactly clarified, feathering and intercolor bleeding are effectively restrained since the viscosity of the ink rapidly increases as the temperature of the ejected ink on a recording medium decreases, from the low viscosity of the ink when heated to be ejected.

The piezo inkjet system can eject a liquid having a high viscosity, which can be restrained from the spreading over the recording paper, therefore it is thought that feathering and intercolor bleeding are effectively restrained, although not exactly clarified.

In the ink ejecting device of the invention, the mass ratio of a quantity of ink application to a quantity of processing solution application for forming one pixel is preferably 1:20 to 20:1, more preferably 1:10 to 10:1, further more preferably 1:5 to 5:1. In the case that the quantity of the ink application is excessive relative to the quantity of the processing solution application, aggregation becomes insufficient, and reduction in optical density, deterioration of ink bleed or deterioration of intercolor bleeding may take place. On the other hand, in the case that the quantity of the processing solution application is excessive relative to the quantity of the ink application, the quantity of the solution becomes large, and a longer time for drying or deterioration of curling may arise. Here, the pixel is a grid point formed by separating a desired image into minimum distances where the ink is applicable in the fast scanning direction and the slow scanning direction, and an appropriate ink set is applied to each pixel, and the color and image density are adjusted to form an image.

In a case that the processing solution is used for recording, the ink and the processing solution are applied onto a recording medium such that they contact with each other, whereby the ink aggregates by the action of the aggregating agent. In this way, the recording method which excels in the color development, color evenness color in the painted area, optical density, prevents feathering and intercolor bleeding, and shortens the drying time can be obtained. The ink and the processing solution may be put either adjacently or in layers, as long as they are in contact with each other.

Ink and processing solution are applied onto a recording medium in order of the processing solution and ink. Because of applying the processing solution first, the constituent components of the ink can be effectively coalesced. The ink may be applied onto the medium at any time as long as the processing solution has been applied, but preferably at 0.5 second or less after the processing solution has been applied.

In the ink ejecting device of the invention, the liquid mass of each of the ink and processing solution per one drop is preferably 0.01 to 25 ng, more preferably 0.5 to 20 ng, and further more preferably 0.5 to 15 ng. When the liquid mass exceeds 25 ng per one drop, not only an ink bleed is deteriorated, but the amount of the ink adhered to the nozzle face becomes large, and re-dispersion of the adhered ink may be difficult. When the liquid mass is less than 0.01 ng per one drop, the ejection stability may be deteriorated. Here, in an inkjet recording apparatus capable of ejecting drops having a plurality of volumes, the drop quantity refers to the drop quantity of a printable minimum quantity.

Hereinafter, preferred embodiments of the ink ejecting device of the invention will be described with reference to the drawings in detail. In the drawings, members having an equal function have the same denotations, and duplicating explanations therefor are omitted.

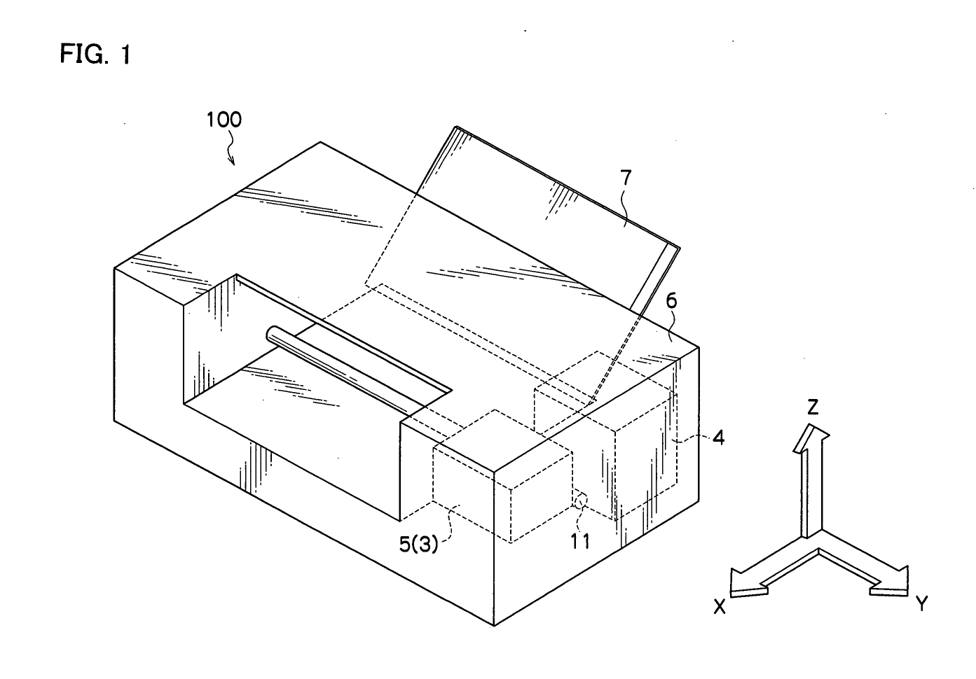

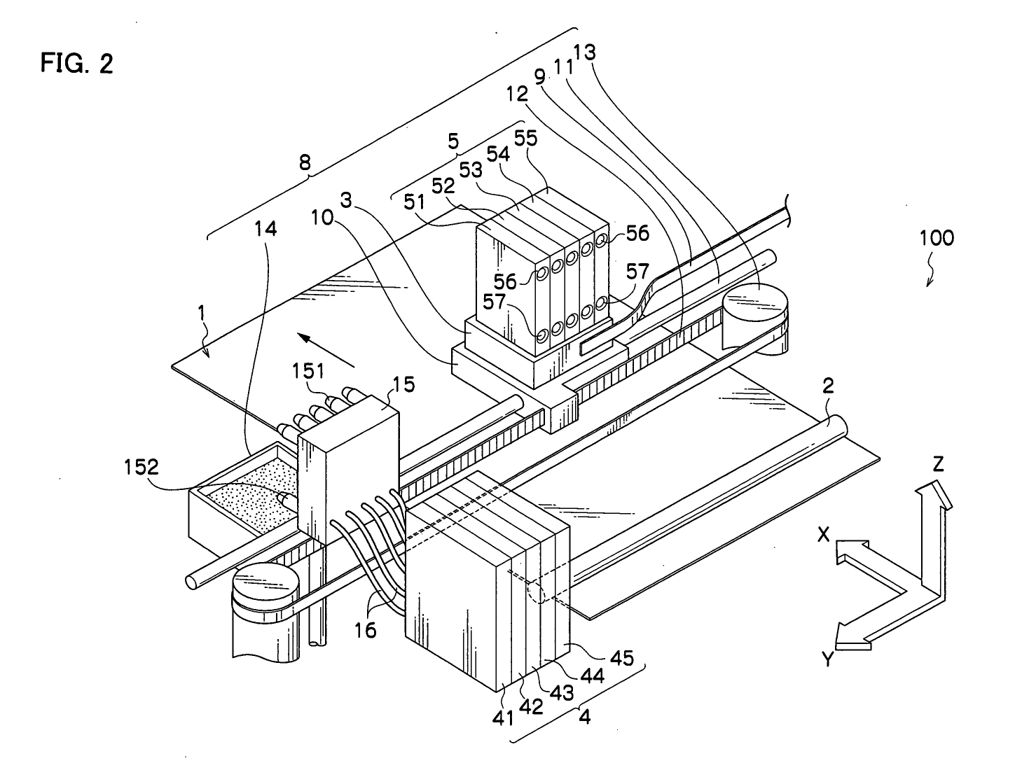

FIG. 1 is a perspective view of an external configuration of a preferable embodiment (recording apparatus for inkjet system) of the ink ejecting device of the invention. FIG. 2 is a perspective view of the interior of the recording apparatus (hereinafter referred to as “image forming apparatus”) of FIG. 1. The image forming apparatus 100 of the present embodiment has a constitution for forming an image by the operation based on the inkjet recording system. That is, as shown in FIGS. 1 and 2, the image forming apparatus 100 is constituted by mainly an outer cover 6, a paper feed section 7 that is capable of accommodating therein predetermined numbers of a recording medium 1 such as plain paper, a conveying roller 2 for conveying the recording medium 1 one by one into the image forming apparatus 100, an image forming section 8 for forming an image on the surface of the recording medium 1 by ejecting inks and a liquid composition, and a main ink tank 4 for supplying the inks and the processing solution to respective sub-tanks 5.

The conveying roller 2 forms a paper feed mechanism constituted by a pair of rollers rotatably disposed in the image forming apparatus 100, and nipps the recording medium 1 loaded in the paper feed section 7 and conveys predetermined numbers of the recording medium 1 one by one at a predetermined timing into the image forming apparatus 100.

The image forming section 8 forms an ink image on the surface of the recording medium 1. The image forming section 8 is mainly constituted by a recording head 3, a sub-ink tank 5, a feeder signal cable 9, a conveying stand 10, a support rod 11, a timing belt 12, a drive pulley 13 and a maintenance unit 14.

The sub ink tank 5 comprises ink tank units 51, 52, 53, 54 and 55, which respectively contain ink of different color or processing solution so as to be ejected from the recording head. In each ink tank unit 51 to 55, for example, a black ink (K), a yellow ink (Y), a magenta ink (M), a cyan ink (C) or a processing solution may be contained. When the processing solution is not used, or a colorant is included in the processing solution, there is of course no need for an ink tank for the processing solution.

Sub ink tank unit 5 has an exhaust opening 56 and a replenishment opening 57. When the recording head 3 is at a stand-by position (or a replenishment position), an exhaust pin 151 and a replenishment pin 152 of a replenish device 15 are respectively inserted into the exhaust opening 56 and the replenishment opening 57, so that the sub ink tank 5 and the replenishment device 15 are connected with each other. The replenishment device 15 is connected to the main ink tank 4 via replenishment tubes 16. The ink replenishment device 15 sends ink and processing solution from the main ink tank 4, through the replenishment openings 57, to replenish the sub ink tank 5.

The main ink tank 4 comprises main ink tank units 41, 42, 43, 44 and 45 each containing ink of different color or processing solution. For example, each main ink tank unit 41 to 45 may contain a black ink (K), a yellow ink (Y), a magenta ink (M), and a cyan ink (C) as the first liquid and a processing solution as the second liquid, and each unit is stored in the image forming apparatus 100 in such a manner that the units can be detached.

Further, as shown in FIG. 2, the feeder signal cable 9 and the sub ink tank 5 are connected to the recording head 3. When an exterior image recording information is transmitted to the recording head 3 via the feeder signal cable 9, the recording head 3 suctions the predetermined amounts of ink from the ink tank and ejects them onto the surface of the recording medium, in accordance with the image-recording information. The feeder signal cable 9 not only transmits the image-recording information, but also powers the recording head 3 to drive the recording head 3.

The recording head 3 is disposed and retained on the carriage 10. The carriage 10 is connected to the guide rod 11 and the timing belt 12 which is connected to the driving pulley 13. In this structure, the recording head 3 can move in the direction of fast scanning direction Y. which is parallel to the surface of the recording medium 1 and perpendicular to the direction of the conveyance direction (slow scanning direction)X, along with the guide rod 11. Meanwhile, Z represents the direction perpendicular to the plane defined by the direction X and the direction Y.

The image forming apparatus 100 further comprises a control element (not shown) which controls the timing to drive the recording head 3 and the timing to drive the carriage 10 in accordance with the image-recording information. In this structure, the image can continuously be formed in the specified area on the surface of the recording medium I which is conveyed at a predetermined velocity in the conveyance direction X, in accordance with the image-recording information.

The maintenance unit 14 is connected to a decompressor (not shown) via a tube. The maintenance unit 14 is also connected to a nozzle part of the recording head 3 and suctions ink from the nozzles of the recording head 3 by reducing the pressure inside the nozzles. By providing the maintenance unit 14, the unnecessary ink attached to the nozzles may be removed while the image forming device 100 is in operation, or the ink may be prevented from evaporating through the nozzles when the image forming device 100 is not in operation, if necessary.

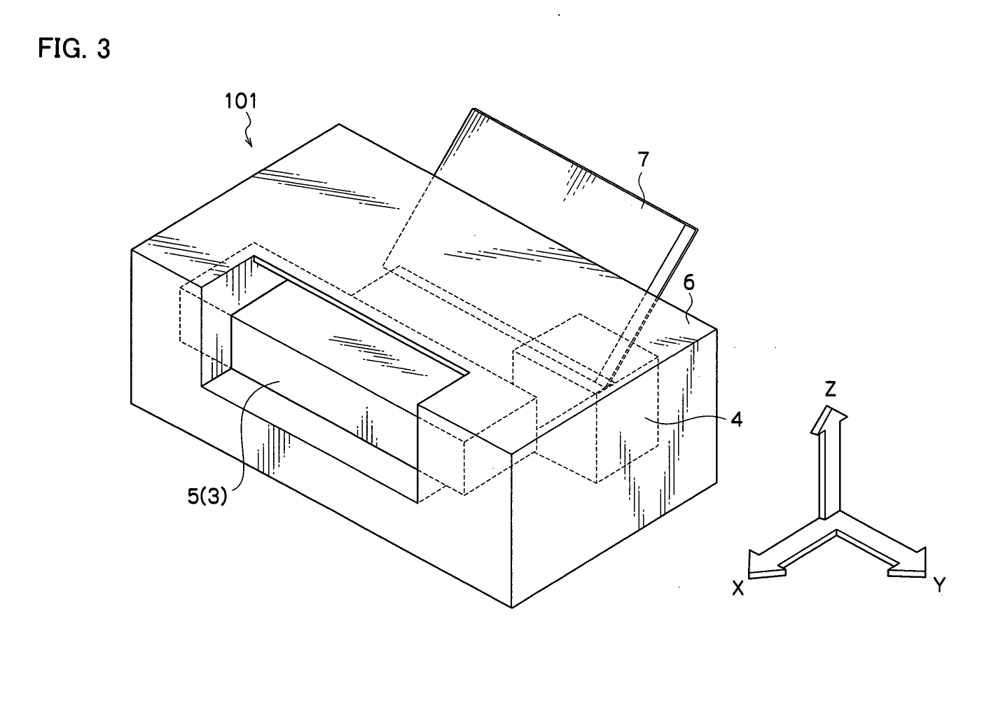

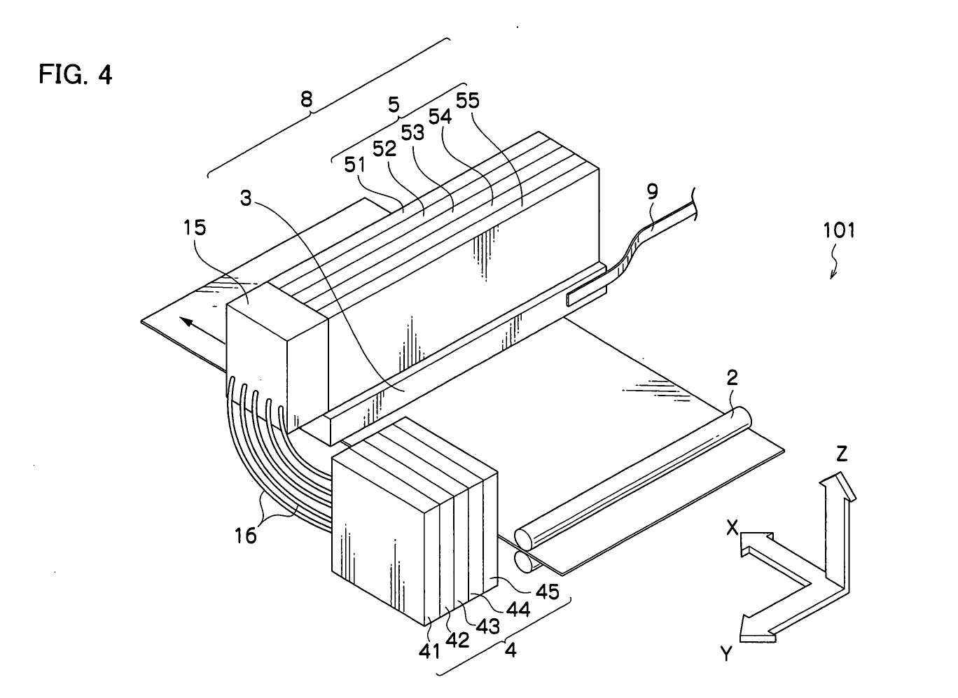

FIG. 3 is a perspective view illustrating the external constitution of another preferable embodiment of the inkjet ejecting apparatus of the present invention. FIG. 4 is a perspective view illustrating the basic interior constitution of the inkjet recording apparatus (occasionally referred to as “image forming apparatus” hereinafter) of FIG. 3. The image forming apparatus 101 in this embodiment has the structure wherein an image is formed in accordance with the inkjet recording method of the present invention.

In the image forming apparatus 101 shown in FIGS. 3 and 4, the width of the recording head 3 is equal to or larger than the width of the recording medium 1, no carriage structure is provided, and the sheet conveyance system is designed to be in the direction of slow scanning direction X (the direction wherein the recording medium 1 is conveyed: the direction of an arrow X). The sheet conveyance system of this embodiment is described as the transportation rollers, but other structures such as a belt-type structure are also applicable.

The nozzles (now shown) to eject the inks of each color and the processing liquid are also aligned in the direction of slow scanning direction X (the direction wherein the recording medium 1 is conveyed: the direction of an arrow X), as with the ink tank units 51 to 55 aligned in the slow scanning direction. Other structures shown in FIGS. 3 and 4, which are the same as the structures shown in the image forming apparatus 100 in FIGS. 1 and 2, are not particularly described herein.

Although the main ink tank 5 is designed to constantly connect to the replenishment device 15 since the recording head 3 is designed to be fixed in the FIGS. 3 and 4, the main ink tank 5 may also be connected to the replenishment device 15 only at the time of replenishment of the ink.

In the image forming apparatus 101 shown in FIGS. 3 and 4, the printing process in the direction of the width of the recording medium 1 (the fast scanning direction) is collectively carried out by the recording head 3. Therefore, the apparatus 101 is simpler in the structure and higher in the printing speed compared to the apparatus having a carriage system.

The ink, ink set, and recording device according to the invention are applicable for not only a medium having a permeation characteristics such as a plain paper, but also an art paper, a film or a medium having no permeation characteristics such as a metal to be formed an image thereon. Therefore, the present invention is applicable for the fields such as a printing, manufacturing of an electric wiring substrate, manufacturing of a display device such as a color filter, a liquid crystal display or an organic EL display, medical film recording, DNA information recording and a building material such as a wall paper and a decorative paper.

The ink of the invention is most effective for an inkjet recording system, but is applicable to the offset printing, gravure printing, flexographic printing, screen printing and the like.

### EXAMPLES

The present invention will further be explained with reference to, but not limited to, the following specific examples.

<Preparation of Each Ink>

### (Method of Preparation of Grafted Pigment Dispersion)

First, a method of preparing a grafted pigment that is formed by chemically bonding a group having a functional group to the surface of pigment is explained.

### Pretreatment (Pigment-Sashing)

100 parts by mass of pigment is added to 1,000 parts by mass of an aqueous solution in which a nonionic surfactant (OLFINE E 1010, manufactured by Nissin Chemical Industry, Co., Ltd.) is dissolved at a concentration of 0.1% by mass, and is mixed and stirred for 10 minutes while applying ultrasound to the mixture from an ultrasound dispersing machine. The resultant mixture is centrifuged and a supernatant is removed to obtain a solid component. The operation is repeated twice, the resultant solid component is washed with ion-exchange water and dried to obtain a washed pigment.

Grafting Reaction

22 parts by mass of sulfanilic acid is added to 1,000 parts by mass of ion-exchange water, and the mixture is stirred while heated at 75° C. During stirring the mixture, after 100 parts by mass of the washed pigment is added to the mixture, is cooled to room temperature (25° C.) to form a processed dispersion.

In the meanwhile, a mixture of 13 parts by mass of concentrated nitric acid, 10 parts by mass of NaNO₂ and 50 parts by mass of deionized water is prepared and is added dropwise into the processed dispersion. Further, an aqueous solution containing 40 parts by mass of hydrolyzed styrene/n-butyl methacrylate/methacrylic acid copolymer (weight average molecular weight: 7,500; acid value: 200) is added dropwise to the resultant processed dispersion to be reacted at a temperature of 60° C. for 2 hours.

Next, after an aqueous sodium hydroxide solution is added to the reaction system to adjust the pH value to 10 of the system and the system is stirred, solid components are separated by centrifugal separation, and washed with ion-exchange water. The pigment thus obtained is added to ion-exchange water again, and dispersed by an ultrasonic dispersing machine. Thereafter, the resultant dispersion is subjected to centrifugal separation with a centrifugal machine to remove coarse particles, and a pigment dispersion is obtained.

(Ink A)

Using carbon black (MOGUL L, manufactured by Cabot) as a pigment, a pigment dispersion A containing a grafted pigment in accordance with the above described preparation method is obtained.

| | |
|---|---|
| Pigment dispersion A | 5% by mass (pigment content) |
| glycerin | 20% by mass |
| triethylene glycol | 5% by mass |
| diethylene glycol monobutyl ether | 2% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink A.

Ink A has a viscosity of 3.2 mpa·s and a surface tension of 31 mN/m, and the volume average particle diameter of the pigment in the ink is 95 μm. After Ink A is subjected to centrifugal separation using an Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P is 0.15% by mass relative to the total mass of the ink and 2.3% by mass relative to the total mass of the solid components.

The residue (solid components) obtained by centrifugal separation using an Optima XL-90 (manufactured by Beckmann) as a centrifugal machine at a number of revolutions of 60,000 rpm (equivalent to 2×10⁵ G) for 60 minutes is subjected to the aforementioned TGA analysis to obtain the amount of organic components S1. The relationship S1>P is obtained, whereby it is shown that the group having a functional group is chemically bonded to the surface of the processed pigment. Hereinafter, the ratios of the amount of solid components P with respect to the amount of organic components S1 of Inks B to G are obtained in the same way. The results are shown in Table 1.

(Ink B)

Using cyan pigment (C.I. Pigment Blue 15:3) as a pigment, a pigment dispersion B containing a grafted pigment in accordance with the above described preparation method is obtained.

| | |
|---|---|
| Pigment dispersion B | 5% by mass (pigment content) |
| glycerin | 25% by mass |
| propylene glycol | 10% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink B.

Ink B has a viscosity of 4.5 mpa·s and a surface tension of 32 mN/m, and the volume average particle diameter of the pigment in the ink is 73 μm. After Ink B is subjected to centrifugal separation using Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 0.6% by mass relative to the total mass of the ink and 9.2% by mass relative to the total mass of the solid components.

(Ink C)

Using carbon black (MOGUL L) as a pigment, a pigment dispersion C containing a grafted pigment is prepared in accordance with the above described preparation method except that styrene/acrylic acid copolymer (weight average molecular weight: 60,000 and acid value: 300) is used in place of styrene/n-butyl methacrylate/methacrylic acid copolymer.

| | |
|---|---|
| Pigment dispersion C | 5% by mass (pigment content) |
| glycerin | 20% by mass |
| triethylene glycol | 5% by mass |
| diethylene glycol monobutyl ether | 2% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink C.

Ink C has a viscosity of 3.5 mPa·s and a surface tension of 32 mN/m, and the volume average particle diameter of the pigment in the ink is 110 μm. After Ink C is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 1.1% by mass relative to the total mass of the ink and 14.7% by mass relative to the total mass of the solid components.

(Ink D)

Using cyan pigment (C.I. Pigment Blue 15:3) as a pigment, a pigment dispersion D is prepared in accordance with the above described preparation method except that 50% by mass of styrene/maleic acid copolymer (weight average molecular weight: 12,000 and acid value: 300) is used in place of styrene/n-butyl methacrylate/methacrylic acid copolymer.

| | |
|---|---|
| Pigment dispersion D | 5% by mass (pigment content) |
| styrene/maleic acid copolymer | 1% by mass |
| (as described above) | |
| glycerin | 25% by mass |
| propylene glycol | 10% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink D.

Ink D has a viscosity of 4.6 mPa·s and a surface tension of 30 mN/m, and the volume average particle diameter of the pigment in the ink is 84 μm. After Ink D is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 2.1% by mass relative to the total mass of the ink and 23.3% by mass relative to the total mass of the solid components.

(Ink E)

By using carbon black (MOGUL L) as a pigment, a pigment dispersion E is prepared in accordance with the above described preparation method except that 50 parts by mass of styrene/methacrylic acid copolymer (weight average molecular weight: 15,000 and acid value: 250) is used in place of 30 parts by mass of styrene/n-butyl methacrylate/methacrylic acid copolymer, and the number of washing times is once.

| | |
|---|---|
| Pigment dispersion E | 5% by mass (pigment content) |
| styrene/methacrylic acid copolymer (as | 1.5% by mass |
| described above) | |
| glycerin | 20% by mass |
| triethylene glycol | 5% by mass |
| diethylene glycol monobutyl ether | 2% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink E.

Ink E has a viscosity of 3.3 mPa·s and a surface tension of 31 mN/m, and the volume average particle diameter of the pigment in the ink is 92 μm. After Ink E is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 3.5% by mass relative to the total mass of the ink and 28.1% by mass relative to the total mass of the solid components.

(Ink F)

Using cyan pigment (C.I. Pigment Blue 15:3) as a pigment, a pigment dispersion F is prepared in accordance with the above described preparation method except that 50 parts by mass of styrene/acrylic acid copolymer (weight average molecular weight: 15,000 and acid value: 100) is used in place of 30 parts by mass of styrene/n-butyl methacrylate/methacrylic acid copolymer, and the number of washing times is once.

| | |
|---|---|
| Pigment dispersion F | 5% by mass (pigment content) |
| styrene/acrylic acid copolymer (as | 2% by mass |
| described above) | |
| glycerin | 25% by mass |
| propylene glycol | 10% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink F.

Ink F has a viscosity of 4.1 mPa·s and a surface tension of 33 mN/m, and the volume average particle diameter of the pigment in the ink is 80 μm. After Ink F is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 4.2% by mass relative to the total mass of the ink and 32.5% by mass relative to the total mass of the solid components.

(Ink G)

By using carbon black (MOGUL L) as a pigment, a pigment dispersion G is prepared in accordance with the above described preparation method except that the addition amount of styrene/n-butyl methacrylate/methacrylic acid copolymer is changed to 20 parts by mass.

| | |
|---|---|
| Pigment dispersion G | 5% by mass (pigment content) |
| glycerin | 20% by mass |
| triethylene glycol | 5% by mass |
| diethylene glycol monobutyl ether | 2% by mass |
| surfactant (OLFINE E1010, | 1% by mass |
| manufactured by Nisshin Chemical | |
| Industry Co., Ltd.) | |
| water | balance |

The above components are mixed and stirred, and resultant liquid is filtered through a filter with 5 μm pores to obtain Ink G.

Ink G has a viscosity of 3.0 mPa·s and a surface tension of 32 mN/m, and the volume average particle diameter of the pigment in the ink is 95 μm. After Ink G is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 0.08% by mass relative to the total mass of the ink and 0.9% by mass relative to the total mass of the solid components.

(Ink I)

75 parts by mass of a 10% by mass aqueous solution of styrene/methacrylic acid copolymer (weight average molecular weight: 6,000, acid value: 250 and neutralization degree: 90%) is added to 125 parts of ion-exchange water and mixed. While stirring of the mixture is continued, 50 parts of carbon black (MOGUL L) as a pigment is slowly added to the mixture to obtain a dispersion. The dispersion is subjected to ultrasonic treatment by an ultrasonic homogenizer for 15 minutes, and is cooled to room temperature (25° C.). After an aqueous sodium hydroxide solution is added to the reaction system to adjust the pH value to 9 of the system and the system is stirred, solid components are separated by centrifugal separation (at 8,000 rpm for 30 minutes). The process by the use of the homogenizer is repeated twice and the resultant pigment (solid component) thus obtained is added to ion-exchange water again, and dispersed by an ultrasonic dispersing machine. Thereafter, the resultant dispersion is subjected to centrifugal separation by a centrifugal machine to remove coarse particles, and a pigment dispersion is obtained.

| | |
|---|---|
| Pigment dispersion I | 5% by mass (pigment content) |
| glycerin | 25% by mass |
| diethylene glycol | 5% by mass |
| diethylene glycol monobutyl ether | 5% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink I.

Ink G has a viscosity of 4.1 mPa·s and a surface tension of 32 mN/m, and the volume average particle diameter of the pigment in the ink is 105 μm. After Ink I is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 0.7% by mass relative to the total mass of the ink and 11.7% by mass relative to the total mass of the solid components.

The residue (solid components) obtained by centrifugal separation using an Optima XL-90 (manufactured by Beckmann) as a centrifugal machine at a number of revolutions of 60,000 rpm (equivalent to 2×10⁵ G) for 60 minutes is subjected to the aforementioned TGA analysis to obtain the amount of organic components S1. The relationship S1>P is not established, and therefore, styrene/methacrylic acid copolymer is not chemically bonded to the surface of the particles of the treated pigment. Hereinafter, the ratios of the amount of solid components P with respect to the amount of organic components S1 of Inks J to L are obtained in the same way. The results are shown in Table 1.

(Ink J)

100 parts by mass of a 10% by mass aqueous solution of styrene/methacrylic acid copolymer (weight average molecular weight: 8,000, acid value: 400 and neutralization degree: 90%) is added to 125 parts of ion-exchange water and mixed. While stirring of the mixture is continued, 50 parts of a cyan pigment (C.I. Pigment Blue 15:3) as a pigment is slowly added to the mixture to obtain a dispersion. The dispersion is subjected to ultrasonic treatment by an ultrasonic homogenizer for 15 minutes, and is cooled to room temperature (25 ° C.). After an aqueous sodium hydroxide solution is added to the reaction system to adjust the pH value to 9 of the system and the system is stirred, solid components are separated by centrifugal separation (at 8,000 rpm for 30 minutes). The process by the use of the homogenizer is repeated twice and the resultant pigment (solid component) thus obtained is added to ion-exchange water again, and dispersed by an ultrasonic dispersing machine. Thereafter, the resultant dispersion is subjected to centrifugal separation by a centrifugal machine to remove coarse particles, and a pigment dispersion is obtained.

| | |
|---|---|
| Pigment dispersion J | 5% by mass (pigment content) |
| glycerin | 25% by mass |
| diethylene glycol | 5% by mass |
| diethylene glycol monobutyl ether | 5% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink J.

Ink J has a viscosity of 4.0 mPa·s and a surface tension of 31 mN/m, and the volume average particle diameter of the pigment in the ink is 88 μm. After Ink J is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 0.8% by mass relative to the total mass of the ink and 13.3% by mass relative to the total mass of the solid components.

(Ink K)

By using carbon black (MOGUL L) as a pigment, a pigment dispersion K is prepared in accordance with the above described preparation method except that the number of washing times is 5 times, and the addition amount of styrene/n-butyl methacrylate/methacrylic acid copolymer is changed to 20 parts by mass.

| | |
|---|---|
| Pigment dispersion K | 5% by mass (pigment content) |
| glycerin | 20% by mass |
| triethylene glycol | 5% by mass |
| diethylene glycol monobutyl ether | 2% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink K.

Ink K has a viscosity of 3.6 mPa·s and a surface tension of 31 mN/m, and the volume average particle diameter of the pigment in the ink is 82 μm. After Ink G is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 0% by mass relative to the total mass of the ink and 0.05% by mass relative to the total mass of the solid components.

(Ink L)

By using carbon black (MOGUL L) as a pigment, a pigment dispersion L is prepared in accordance with the above described preparation method except that washing is not performed, and the addition amount of styrene/n-butyl methacrylate/methacrylic acid copolymer is changed to 60 parts by mass.

| | |
|---|---|
| Pigment dispersion L | 5% by mass (pigment content) |
| styrene/n-butyl methacrylate/ | 2.5% by mass |
| methacrylic acid copolymer (as | |
| described above) | |
| glycerin | 25% by mass |
| propylene glycol | 10% by mass |
| surfactant (OLFINE E1010, | 1% by mass |
| manufactured by Nisshin Chemical | |
| Industry Co., Ltd.) | |
| water | balance |

The above components are mixed and stirred, and the resultant liquid is filtered through a filter with 5 μm pores to obtain Ink L.

Ink L has a viscosity of 4.5 mPa·s and a surface tension of 33 mN/m, and the volume average particle diameter of the pigment in the ink is 79 μm. After Ink L is subjected to centrifugal separation by the use of Optima XL-90 (manufactured by Beckmann) as a centrifugal machine at a number of revolutions of 60,000 rpm (equivalent to 2×10⁵ G) for 60 minutes, the amount of solid components P in the supernatant after the centrifugal separation is obtained by the aforementioned GPC analysis, and the ratio of the amount of solid components P in the supernatant after the centrifugal separation is 5.5% by mass relative to the total mass of the ink and 40% by mass relative to the total mass of the solid components.

### Example 1

Using Ink A, the following evaluation is carried out.

### (Re-Dispersion Characteristics)

30 g of the ink is placed in a beaker, and allowed to stand for 7 days at ordinary temperature and pressure. Water is added to the resultant solid component to give a total amount of 30 g. The volume average particle diameters of the initial ink and the ink after re-dispersion are measured by the use of Microtrack UPA Particle Size Analyzer 9340 (manufactured by Leeds & Northrup). The evaluation is based on the ratio of the volume average particle diameter of the ink after re-dispersion to the volume average particle diameter of the initial ink.

Evaluations are performed on the basis of the following judgment criteria based on the above results.
A: Ratio of the volume average particle diameter of the ink after re-dispersion to the volume average particle diameter of the initial ink is less than 1.5;
B: Ratio of the volume average particle diameter of the ink after re-dispersion to the volume average particle diameter of the initial ink is 1.5 or more and less than 2;
C: Ratio of the volume average particle diameter of the ink after re-dispersion to the volume average particle diameter of the initial ink is 2 or more and less than 5; and
D: Ratio of the volume average particle diameter of the ink after re-dispersion to the volume average particle diameter of the initial ink is 5 or more.

Results are shown in Table 1.

(Failure of Ink Ejection Direction After Ink is Stored for a Long Period of Time)

A trial piezo type inkjet head having a nozzle density of 1,200 dpi×600 dpi (dpi: dot number per one inch) of a printer is loaded with the inks prepared by the methods in the above. The printer with capped nozzles is allowed to stand for 15 days under ordinary environment, and after a prescribed maintenance operation is performed, a nozzle check pattern is printed to observe the number of nozzles that eject onto the regular positions without failure of ink ejection direction of 1024 ink ejecting nozzles.
A: nozzles eject normally without failure of ink ejection direction are 95% or more (973 nozzles or more);
B: nozzles eject normally without failure of ink ejection direction are 92.5% or more and less than 95% (947 nozzles or more to less than 973 nozzles)
C: nozzles eject normally without failure of ink ejection direction are 90% or more and less than 92.5% (922 nozzles or more and less than 947 nozzles), and
D: nozzles eject normally without failure of ink ejection direction are less than 90% (less than 922 nozzles).

Results are shown in Table 1.

### Examples 2-7, and Comparative Examples 1-4

Evaluations are performed in a similar manner to those of Example 1, except that the inks enumerated in Table are used instead of Ink A.

Results are shown in Table 1.

TABLE 1

| | Ink | | | | | | |
|---|---|---|---|---|---|---|---|
| | | | Ratio of solid | Ratio of solid | | | |
| | | Group | component | component | | | Ratio of amount of |
| | | having a | to total ink | to total solid | | Failure of ejection | solid components P |
| | | functional | amount (% by | amount (% by | | direction after | to amount of organic |
| | No. | group | mass) | mass) | Redispersibility | storage for long time | components S1 (P/S1) |
| Example 1 | A | Chemically | 0.15 | 2.3 | B | C | 0.08 |
| | | bonded | | | | | |
| Example 2 | B | Chemically | 0.6 | 9.2 | A | A | 0.32 |
| | | bonded | | | | | |
| Example 3 | C | Chemically | 1.1 | 14.7 | A | A | 0.52 |
| | | bonded | | | | | |
| Example 4 | D | Chemically | 2.1 | 23.3 | B | B | 0.70 |
| | | bonded | | | | | |
| Example 5 | E | Chemically | 3.5 | 28.1 | B | C | 0.59 |
| | | bonded | | | | | |
| Example 6 | F | Chemically | 4.2 | 32.5 | B | C | 0.69 |
| | | bonded | | | | | |
| Example 7 | G | Chemically | 0.08 | 0.9 | C | C | 0.054 |
| | | bonded | | | | | |
| Comparative | I | — | 0.7 | 11.7 | D | D | 1 |
| Example 1 | | | | | | | |
| Comparative | J | — | 0.8 | 13.3 | D | D | 1 |
| Example 2 | | | | | | | |
| Comparative | K | Chemically | 0 | 0.05 | D | D | 0.02 |
| Example 3 | | bonded | | | | | |
| Comparative | L | Chemically | 5.5 | 40 | D | D | 0.58 |
| Example 4 | | bonded | | | | | |

As shown in Table 1, Examples 1 to 7 in which the inks that contain the grafted pigments and the amount of solid components in a predetermined range after centrifugation are used, show not only a superior ink dispersion stability, but an excellent re-dispersibility after solidification, and problems in ink ejecting characteristics after storage over a long period of time are not caused even when the inks are used in the inkjet heads. In contrast, Comparative Examples in which the inks that do not contain the grafted pigments or the amount of solid components is not in a predetermined range even if the inks contain the grafted pigments after centrifugation, and problems in either re-dispersibility or ink ejecting characteristics after storage over a long period of time are caused.

The present invention can provide ink, an ink cartridge and an ink ejecting device that can easily re-disperse solidified colorant in ink even if solvent is evaporated and the ink is solidified in an aqueous ink containing pigment in which a group having a functional group is chemically bonded to the surface of the pigment.

What is claimed is:

1. An ink comprising a pigment, in which a group having a functional group is chemically bonded to the surface of the pigment, water, and a water-soluble organic solvent, an amount of solid components having a molecular weight of 500 or more in the supernatant when the ink is subjected to centrifugation at a gravitational acceleration of 2×10⁵ G for 60 minutes being in the range of from approximately 0.1 to approximately 35% by mass with respect to the total amount of solid components in the ink.

2. The ink according to claim 1, wherein the amount of solid components is in the range of from approximately 1 to approximately 25% by mass.

3. The ink according to claim 1, wherein the amount of solid components is in the range of from approximately 1.5 to approximately 15% by mass.

4. The ink according to claim 1, wherein the amount of solid components having a molecular weight of 500 or more in the supernatant when the ink is subjected to centrifugation at a gravitational acceleration of 2×10⁵ G for 60 minutes being in the range of from approximately 0.05 to approximately 5% by mass with respect to the total amount of the ink.

5. The ink according to claim 4, wherein the amount of solid components is in the range of from approximately 0.1 to approximately 4% by mass.

6. The ink according to claim 4, wherein the amount of solid components is in the range of from approximately 0.25 to approximately 3% by mass.

7. The ink according to claim 1, wherein the group having a functional group comprises an organic group and a functional group, the organic group being chemically bonded to the surface of the pigment.

8. The ink according to claim 1, wherein the group having a functional group bonded to the surface of the pigment is an organic component, and P/S1 is less than approximately 1, wherein S1 represents an amount of organic components in the pigment and P represents an amount of solid components having a molecular weight of 500 or more in the supernatant when the ink is subjected to centrifugation at a gravitational acceleration of 2×10⁵ G for 60 minutes.

9. The ink according to claim 8, wherein P/S1 is approximately 0.05 or more and less than approximately 0.9.

10. The ink according to claim 1, wherein the ink further comprises a polymer component.

11. An ink cartridge in which the ink according to claim 1 is accommodated.

12. The ink cartridge according to claim 11, wherein the group having a functional group bonded to the surface of the pigment in the ink is an organic component, and P/S1 is less than approximately 1, wherein S1 represents an amount of organic components in the pigment and P represents an amount of solid components having a molecular weight of 500 or more in the supernatant when the ink is subjected to centrifugation at a gravitational acceleration of 2×10⁵ G for 60 minutes.

13. The ink cartridge according to claim 12, wherein P/S1 is approximately 0.05 or more and less than approximately 0.9.

14. An ink ejecting device comprising the ink cartridge according to claim 11, an ink ejecting unit for ejecting ink accommodated in the ink cartridge.

15. The ink ejecting device according to claim 14, wherein the group having a functional group bonded to the surface of the pigment in the ink is an organic component, and P/S1 is less than approximately 1, wherein S1 represents an amount of organic components in the pigment and P represents an amount of solid components having a molecular weight of 500 or more in the supernatant when the ink is subjected to centrifugation at a gravitational acceleration of 2×10⁵ G for 60 minutes.

16. The ink ejecting device according to claim 15, wherein P/S1 is approximately 0.05 or more and less than approximately 0.9.

17. An ink ejecting device comprising the ink cartridge according to claim 11, and an ink ejecting unit for ejecting ink accommodated in the ink cartridge, and a conveying unit for conveying a recording medium, wherein the ink is ejected from the ink ejecting unit onto the recording medium being conveyed by the conveying unit to carry out recording.
